(19) United States
(12) Patent Application Publication
(10) Pub. No.: US 2026/0081771 A1
(43) Pub. Date: Mar. 19, 2026

(54) ENCRYPTION/DECRYPTION METHOD AND DEVICE

(71) Applicant: Montage LZ Technologies (Chengdu) Co., Ltd., Chengdu (CN)

(72) Inventors: Weike RAO, Chengdu (CN); Rui YANG, Chengdu (CN); Chiachen CHANG, Chengdu (CN); Xiaomin SI, Chengdu (CN)

(73) Assignee: Montage LZ Technologies (Chengdu) Co., Ltd., Chengdu (CN)

(21) Appl. No.: 19/308,359

(22) Filed: Aug. 25, 2025

(30) Foreign Application Priority Data
Sep. 14, 2024 (CN) 2024112914426

(51) Int. Cl. H04L 9/08

(52) U.S. Cl. CPC H04L 9/0869; H04L 2209/046

(57) ABSTRACT

An encryption/decryption method and a device. The method includes: performing rounds of operations based on input data and a key to generate output data, each round of operations processes N blocks of data to generate round output data; in each round of operations, the method further includes: performing random masking based on the N−1 blocks of data and a round key rki of the i-th round to generate first data; performing nonlinear transformation on the first data using a masked S-box to generate second data; performing linear transformation on the second data to generate third data; performing a first XOR operation on a remaining one block of data of the current round and the third data to generate fourth data; performing masking on the fourth data to generate the round output data of the current round.

### FIELD OF TECHNOLOGY

The present disclosure belongs to the field of cryptography, and relates to encryption/decryption methods, and in particular to an encryption/decryption method and device.

### BACKGROUND

Block Cipher, also known as block encryption or block passwords, is a symmetric cryptographic algorithm. Block cipher algorithms are widely used in various fields such as mobile communications, wireless local area networks, finance, national defense, e-commerce, and video encryption. In a block cipher algorithm, input plaintext data are divided into several fixed-length blocks, and each block is transformed into corresponding ciphertext by a series of operations based on keys. Common block cipher algorithms include Data Encryption Standard (DES), Advanced Encryption Standard (AES), and SM4. However, existing block cipher algorithms exhibit poor resistance to Differential Power Analysis (DPA) attacks.

### SUMMARY

The present disclosure provides an encryption/decryption method, device, storage medium, and electronic equipment, enhancing the capability to resist DPA attacks.

In a first aspect, the encryption/decryption method includes: performing a plurality of rounds of operations based on input data and a key to generate output data, wherein each round of operations processes N blocks of data to generate round output data, wherein the N blocks of data in a first round of operations are obtained by random masking the input data, and the N blocks of data in each of remaining rounds of operations are obtained based on N−1 blocks of data and the round output data from a previous round, and wherein N is a positive integer greater than 1; in each round of operations, the method further includes: performing random masking based on the N−1 blocks of data and a round key rkᵢ of the i-th round to generate first data, wherein the round keys are generated by a key generator; performing a first XOR operation on a remaining one block of data of the current round and the third data by a first XOR operation unit to generate fourth data; and performing masking on the fourth data by a masking processor to generate the round output data of the current round.

In one embodiment of the first aspect, the method further includes: performing a second XOR operation on N first random numbers and the input data by a second XOR operation unit to generate the N blocks of data for the first round of operations, wherein the first random numbers are generated by a random number generator.

In one embodiment of the first aspect, the method further includes: performing, by the key generator, a third XOR operation on N second random numbers and the key, and performing key expansion based on a result of the third XOR operation to generate the round keys, wherein the second random numbers are generated by the random number generator.

In one embodiment of the first aspect, performing random masking based on the N−1 blocks of data and a round key rkᵢ of the i-th round to generate first data includes: performing a fourth XOR operation on a round random number, said round key, and the N−1 blocks of data of the current round by a fourth XOR operation unit to generate the first data.

In one embodiment of the first aspect, the method further includes: generating the round random number using a third random number, wherein the round random number varies across different rounds, and the third random number is generated by the random number generator.

In one embodiment of the first aspect, performing nonlinear transformation on the first data by the nonlinear processor using the masked S-box to generate the second data includes: performing affine transformation on the first data to generate fifth data; performing mask inversion on the fifth data in Galois field to generate sixth data; and performing affine transformation on the sixth data to generate the second data.

In one embodiment of the first aspect, the method further includes: adding the round output data from the previous round to the N−1 blocks of data from the previous round to form the N blocks of data of the current round of operations.

In one embodiment of the first aspect, the method further includes: adding the round output data from a final round after the N−1 blocks of data from the final round to form seventh data; performing a reverse-order processing on the seventh data to generate eighth data; and performing unmasking on the eighth data to generate the output data.

In one embodiment of the first aspect, the input data are plaintext data and the output data are ciphertext data, and the input data are ciphertext data and the output data are plaintext data.

In one embodiment of the first aspect, N=4, and the plurality of rounds of operations consists of 32 rounds of operations.

In a second aspect, the encryption/decryption device, includes: a data acquisition module, configured to acquire input data; a key acquisition module, configured to acquire a key and generate a plurality of round keys by a key generator; and an encryption/decryption module, configured to perform a plurality rounds of operations based on the input data and the key to generate output data, wherein each round of operations processes N blocks of data to generate round output data, wherein the N blocks of data in a first round of operations are obtained by random masking the input data, and the N blocks of data in each of remaining rounds of operations are obtained based on N−1 blocks of data and the round output data from a previous round, wherein N is a positive integer greater than 1; wherein in each round of operations, the encryption/decryption module is configured to: perform random masking based on the N−1 blocks of data and a round key rkᵢ of the i-th round to generate first data, wherein the round keys are generated by a key generator; perform nonlinear transformation on the first data using at least one masked S-box by a nonlinear processor to generate second data; perform linear transformation on the second data by a linear processor to generate third data; perform a first XOR operation on a remaining one block of data of the current round and the third data by a first XOR operation unit to generate fourth data; and perform masking on the fourth data by a masking processor to generate the round output data of the current round.

### BRIEF DESCRIPTION OF THE DRAWINGS

FIG. 1 shows a schematic diagram of a block cipher algorithm in related technical solutions.

FIG. 2 shows a flowchart of an i-th round operation according to one embodiment of the present disclosure.

FIG. 3A shows a flowchart of data processing using a masked S-box according to one embodiment of the present disclosure.

FIG. 3B shows a schematic diagram of data processing using a masked S-box according to one embodiment of the present disclosure.

FIG. 3C shows a flowchart of a mask inversion according to one embodiment of the present disclosure.

FIG. 4 shows a flowchart for generating output data according to one embodiment of the present disclosure.

FIG. 5 shows an overall schematic diagram of an encryption method according to one embodiment of the present disclosure.

FIG. 6 shows a schematic structural diagram of an encryption/decryption device according to one embodiment of the present disclosure.

### DETAILED DESCRIPTION

Embodiments of the present disclosure will be described below. Those skilled can easily understand advantages and effects of the present disclosure according to contents disclosed by the specification. The present disclosure may also be implemented or applied through other different specific embodiments. Various details in this specification may also be modified or changed based on different viewpoints and disclosures without departing from the spirit of the present disclosure. It should be noted that the following embodiments and the features of the following embodiments may be combined with each other if no conflict will result.

It should be noted that the drawings provided in this disclosure only illustrate the basic concept of the present disclosure in a schematic way, so the drawings only show the components closely related to the present disclosure. The drawings are not necessarily drawn according to the number, shape, and size of the components in actual implementation; during the actual implementation, the type, quantity, and proportion of each component may be changed as needed, and the layout of the components may also be more complicated.

In the description of the present disclosure, the terms “first” and “second” are used for descriptive purposes only, and are not to be understood as indicating or implying relative importance or implicitly specifying the number of technical features indicated. Thus, features qualified with terms like “first” and “second” may explicitly or implicitly comprise one or more such features. In the description of the present application, “more than one” means two or more, unless otherwise expressly and specifically limited.

In the present disclosure, unless otherwise expressly specified and limited, the terms “connected” and “connected” are to be understood broadly, e.g., mechanically connected or electrically connected, directly connected, or indirectly connected by an intermediate medium, connected within two elements, or between two elements. Connectivity within two elements or an interactive relationship between two elements. For those of ordinary skill in the art, the specific meaning of the above terms in the present disclosure may be understood on a case-by-case basis.

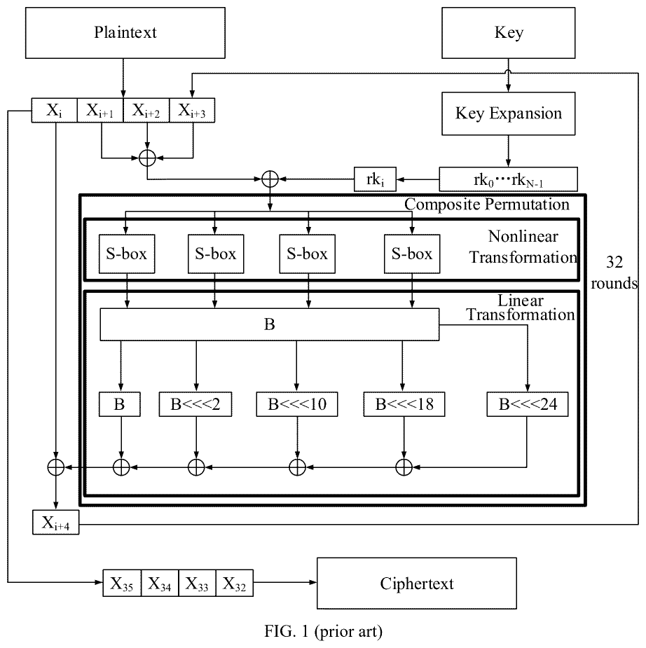

FIG. 1 shows a schematic diagram of a block encryption process in related technical solutions, where plaintext is taken as an example, which is divided into four data blocks (i.e., four blocks of data). As shown in FIG. 1, the block encryption process includes 32 rounds of iterative operations. In the i-th round of operation, four blocks of data Xᵢ, Xᵢ₊₁, Xᵢ₊₂, Xᵢ₊₃ are processed to generate round output data Xᵢ₊₄, in the (i+1)-th round of operation, the four blocks of data Xᵢ₊₁, Xᵢ₊₂, Xᵢ₊₃, Xᵢ₊₄ are processed to generate round output data Xᵢ₊₅, and so on, where i=0, 1, . . . 31. However, the block encryption process has poor resistance to DPA attacks. The DPA attack is a physical-level attack technique that exploits the power consumption variations of a cryptographic device under different input data or keys. By analyzing the power consumption waveforms, it is possible to infer the internal operations of the device and related information. In the block encryption scheme shown in FIG. 1, the data within the encryption engine is closely related to the plaintext, so attackers can obtain information about the cryptographic algorithms and keys by inputting specific plaintexts and monitoring power consumption patterns of the device.

At least in light of the above-mentioned problems, embodiments of the present disclosure provide an encryption/decryption method. Taking encryption as an example, the technical solution of the present disclosure will be described in detail with reference to accompanying drawings.

The encryption method includes: performing P+1 rounds of operations based on input data and a key to generate output data, where P is a positive integer. Each round of operation is used to process N blocks of data to generate respective round output data. Each block of data and each round output data are of equal size, for example, 32 bits. N is a positive integer greater than 1. The N blocks of data in a first round of operations are obtained by random masking the input data, and the N blocks of data in each of remaining rounds of operations are obtained based on N−1 blocks among the N blocks of data and the round output data from a previous round.

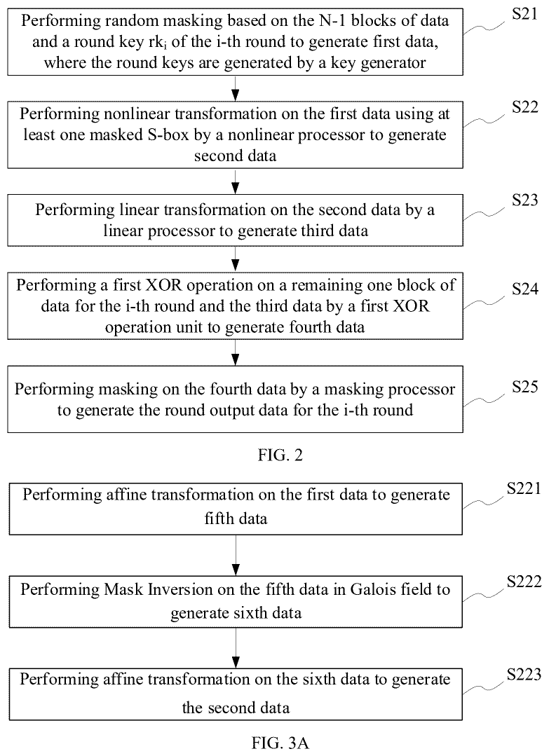

FIG. 2 shows a flowchart of an i-th round operation in one embodiment of the present disclosure, where i=0, 1, . . . , P. As shown in FIG. 2, the i-th round operation includes steps S21-S25.

S21, performing random masking based on the N−1 blocks of data and a round key rkᵢ of the i-th round to generate first data, where the round keys rkᵢ are generated by a key generator. For sake of clarity, the N blocks of data MXᵢ, MXᵢ₊₁, . . . , MX_{i+N-1} of the i-th round will be illustrated next as an example, and the N−1 blocks of data involved in generation of the first data are MXᵢ₊₁, . . . , MX_{i+N-1}.

S22, performing nonlinear transformation on the first data using at least one masked S-box (MS-box) by a nonlinear processor to generate second data. The nonlinear processor, for example, may be implemented by a Digital Signal Processor (DSP), an Application-Specific Integrated Circuit (ASIC), a Field-Programmable Gate Array (FPGA), and so on.

S23, performing linear transformation on the second data by a linear processor to generate third data. The linear processor may be implemented, for example, by a DSP, an ASIC, a FPGA, and so on.

S24, performing a first XOR operation on a remaining one block of data (MXᵢ) of the i-th round and the third data by a first XOR operation unit, to generate fourth data.

S25, performing masking on the fourth data by a masking processor to generate the round output data MX_{i+N} of the i-th round.

If the i-th round is not the final round, the N blocks of data of the (i+1)-th round are obtained based on the N−1 blocks of data of the i-th round (MXᵢ₊₁, . . . , MX_{i+N-1}) and the round output data (MX_{i+N}) of the i-th round. If the i-th round is the final round, unmasking is performed on MXᵢ₊₁, . . . , MX_{i+N-1}, and MX_{i+N} to obtain final output data.

As described above, the encryption method provided in some embodiments of the present disclosure utilizes the masked S-box to perform the nonlinear transformation of the first data, and the resulting second data, as well as the subsequent resulting third and fourth data, are all masked. Therefore, the attackers are unable to obtain information about these data, and they cannot deduce the computation processes or related data inside the engine through methods like power analysis. This method significantly improves resistance to DPA attacks.

In some embodiments, the encryption method may further include: performing a second XOR operation on the N first random numbers mx₀, mx₁, . . . , mx_{N-1} and the input data by a second XOR operation unit to generate the N blocks of data MX₀, MX₁, MX_{N-1} for the first round of operation. The first random numbers are generated by a random number generator, for example, a True Random Number Generator (TRNG). Such a step ensures that the data entering the encryption engine has undergone random masking, and therefore helps enhance data masking during the encryption process.

In some embodiments, the encryption method may further include: performing, by the key generator, a third XOR operation on N second random numbers mk₀, mk₁, . . . , mk_{N-1} and the key, and performing key expansion based on a result of the third XOR operation to generate the round keys rk₀, rk₁, . . . , rk_{N-1}. This step provides additional protection for the key. The second random numbers are generated by a random number generator, for example, a TRNG. The key generator may include a third XOR operation unit.

In some embodiments, performing random masking based on the N−1 blocks of data and a round key rkᵢ of the i-th round to generate first data further includes: performing a fourth XOR operation on a round random number, the round key rkᵢ, and the N−1 blocks of data of the i-th round by a fourth XOR operation unit to generate the first data.

In some embodiments, the round random number is generated using a third random number m_{XN}, where the round random number varies across different rounds. The third random number is generated by a random number generator, for example, a TRNG.

In some embodiments, the third random number may be input into a Linear Feedback Shift Register (LFSR) to generate the round random number. The LFSR operates as follows: In each clock cycle, the data in the register shifts left by one bit, and a new bit determined by a predefined linear feedback polynomial is computed and stored in the rightmost bit of the register. By repeating this process, the LFSR generates a unique random number for each round of operation.

As described above, in some embodiments of the present disclosure, round random numbers may be used to mask the XOR result of the round key rkᵢ and the N−1 blocks of data, and the resulting first data are masked, further enhancing data security.

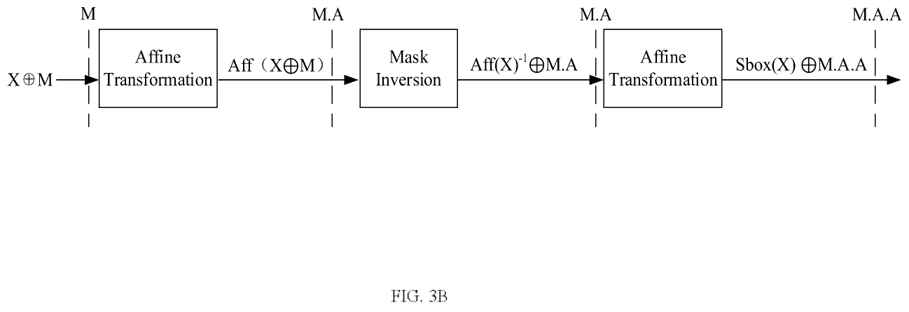

Referring to FIG. 3A, performing nonlinear transformation on the first data using at least one masked S-box by a nonlinear processor to generate second data includes steps S221-S223:

S221, performing affine transformation on the first data to generate fifth data.

S222, performing Mask Inversion on the fifth data in Galois field GF (2⁸) to generate sixth data.

S223, performing affine transformation on the sixth data to generate the second data.

FIG. 3B shows a schematic diagram of data process using a masked S-box to perform nonlinear transformation on the first data X⊕M to generate the second data, where dashed lines and labels above the dashed lines indicate masks applied to respective data. Affine transformation is performed on the first data X⊕M to generate fifth data Aff(X⊕M), where the fifth data are masked by M·A, where A is a Cyclic Matrix, and the fifth data may also be represented as Aff(X)⊕M·A; mask inversion is performed on the fifth data in Galois field to generate sixth data Aff(X)⁻¹⊕M·A, where the sixth data are masked by M·A.; and affine transformation is performed on the sixth data to generate the second data S-box(X)⊕M·A·A, where the second data are S-box(X) masked by M·A·A.

As an example, FIG. 3C shows a flowchart of generating sixth data by mask inversion of a fifth data Y⊕M·A in one embodiment of the present disclosure, where Y=Aff(X). As shown in FIG. 3C, multiplication of Y⊕M·A and M·A is subjected to a fifth XOR operation with (M·A)², Galois Field Inversion is then performed on a result of the fifth XOR operation and then the result thereof is subjected to a sixth XOR operation with 1, and a result of the sixth XOR operation is multiplied by M·A to obtain a result of the final mask inversion: Y⁻¹⊕M·A.

In some embodiments, performing masking on the fourth data by a masking processor to generate the round output data of the i-th round includes: performing a seventh XOR operation on the mask of the third data and the fourth data to generate the round output data of the i-th round.

In some embodiments, if the i-th round is not the final round, adding the round output data MX_{i+N} of the i-th round after the N−1 blocks of data MXᵢ₊₁, . . . , MX_{i+N1} of the i-th round to obtain the N blocks of data of the (i+1)th round, i.e., MXᵢ₊₁, . . . , MX_{i+N-1}, MX_{i+N}.

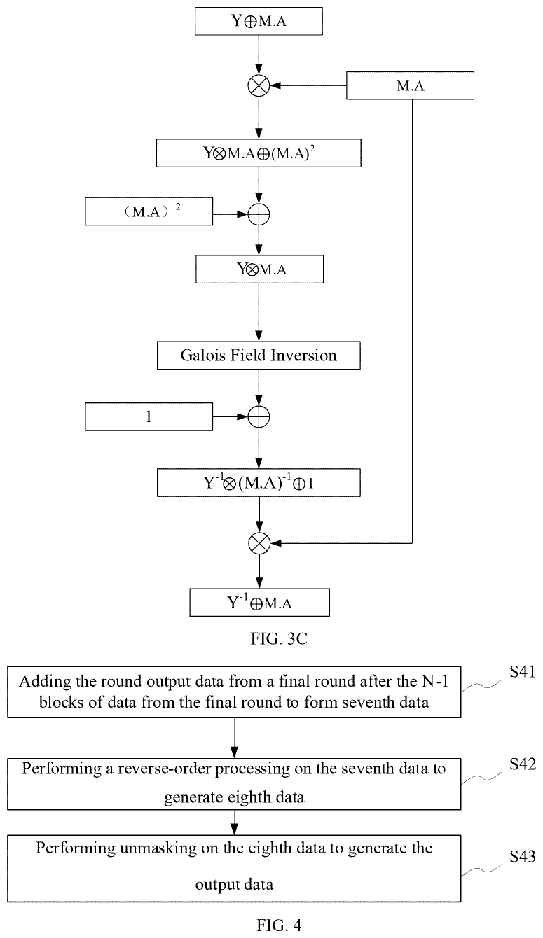

Referring to FIG. 4, in some embodiments, the encryption method of the present disclosure may further include steps S41-S43.

S41, adding the round output data from the final round after the N−1 blocks of data of the final round to form seventh data. As an example, if the blocks of data of the final round are MX_{P+0}, MX_{P+1}, . . . , MX_{P+N-1}, the N−1 blocks of data mentioned above in this step refers to MX_{P+1}, . . . , MX_{P+N-1}, and if the round output data of the final round is MX_{P+N}, then the seventh data are MX_{P+1}, MX_{P+2}, . . . , MX_{P+N}.

S42, performing a reverse-order processing on the seventh data to generate eighth data. As an example, if the seventh data are MX_{P+1}, MX_{P+2}, . . . , MX_{P+N}, the eighth data generated after the reverse-order processing are MX_{P+N}, MX_{P+N-1}, . . . , MX_{P+1}.

S43, performing unmasking on the eighth data to generate the output data.

As an example, performing the unmasking on the eighth data includes: performing a ninth XOR operation on masks of the blocks of data in the final round and the eighth data to generate the final output data.

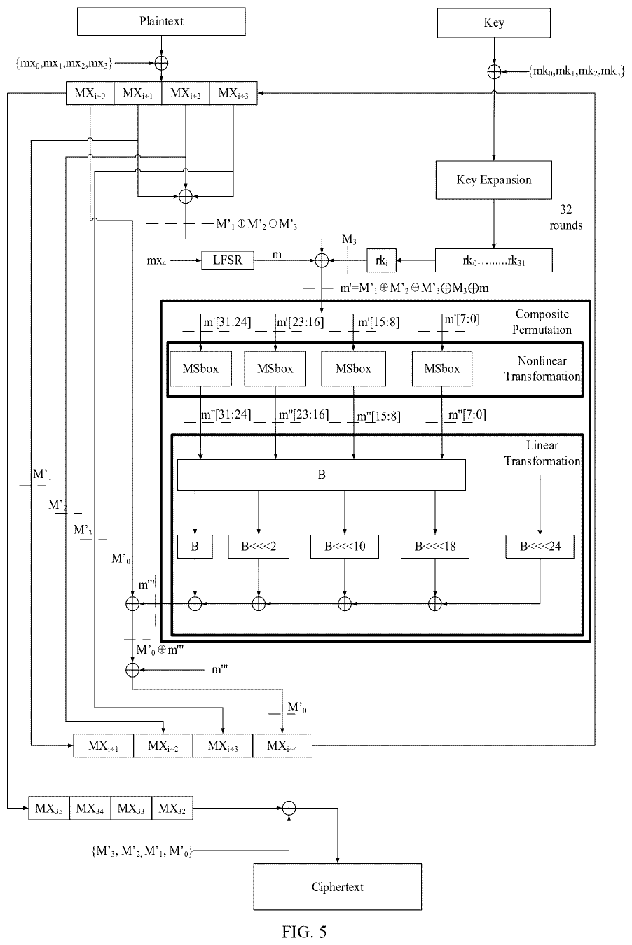

As an example, N=4 and 32 rounds of iterations are carried out (i.e., P=31), as shown in FIG. 5, where labels above dashed lines indicate masks of corresponding data. Herein, the second XOR operation is performed on the input plaintext and the first random numbers mx0, mx1, mx2, mx3 to mask the plaintext, producing the four blocks of data MXᵢ₊₀ to MXᵢ₊₃, and the third XOR operation is performed on the input key and the second random numbers mk0, mk1, mk2, mk3 to mask the key, with the masked key then undergoing key expansion to generate the round keys rk₀ to rk₃₁. Specifically, in the i-th round, the masks of the four blocks of data MXᵢ₊₀ to MXᵢ₊₃ are M₀′ to M₃′, respectively, and the mask of the round key rkᵢ is M₃. After an eighth XOR operation is performed on the three blocks of data MXᵢ₊₁ to MXᵢ₊₃, the fourth XOR operation is then performed on the result of the eighth XOR operation, a round random number m, and the round key rkᵢ to produce the first data, with the mask of the first data being m′=M₁′⊕M₂′⊕M₃′⊕M₃⊕m (the fourth XOR operation and the eighth XOR operation may also be combined, and collectively referred to as the fourth XOR operation). A nonlinear transformation is then performed on the first data using at least one masked S-box (e.g., four) to generate the second data, with the mask of the second data being m″. A linear transformation is then performed on the second data to generate the third data, with the mask of the third data being m′″. The first XOR operation is performed on the remaining one block of data MXᵢ₊₀ of the i-th round and the third data to produce the fourth data, with the mask of the fourth data being M₀′⊕m′″. A seventh XOR operation is then performed on the fourth data and the mask of the third data to generate the round output data MXᵢ₊₄, with the mask of the round output data being M₀′. If the i-th round is not the final round, the updated four blocks of data MXᵢ₊₁, MXᵢ₊₂, MXᵢ₊₃, and MXᵢ₊₄ are used for the next round. If the i-th round is the final round (i.e., i=31), MXᵢ₊₁, MXᵢ₊₂, MXᵢ₊₃, and MXᵢ₊₄, constitute the seventh data, and then the eighth data is obtained after reverse-order processing of the seventh data, that is, the eighth data include MXᵢ₊₄, MXᵢ₊₃, MXᵢ₊₂, and MXᵢ₊₁; then ciphertext data (i.e., final output data) are obtained by performing a ninth XOR operation on the eighth data and the masks M₀′ to M₃′.

The encryption method provided by embodiments of the present disclosure is described above. The decryption method of the present disclosure is similar to the encryption method and is not described herein.

The scope of the encryption/decryption method provided by embodiments of the present disclosure is not limited to the order of execution of the steps enumerated in the present disclosure, and any scheme realized by step addition or subtraction and step substitution of the present technologies made in accordance with the principles of the present disclosure is included in the scope of the present disclosure.

The present disclosure also provides an encryption/decryption device, and the encryption/decryption device can realize the encryption/decryption method previously provided by the present disclosure, but devices suitable for realizing the encryption/decryption method provided by the present disclosure may or may not have the structure of the encryption/decryption device detailed in the present disclosure, and all structural deformations and substitutions made using present technologies in accordance with the principles of the present disclosure are included in the scope of the present disclosure.

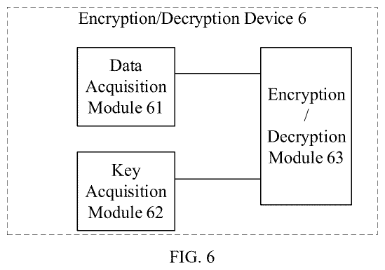

FIG. 6 shows a schematic diagram of a structure of an encryption/decryption device 6 according to one embodiment of the present disclosure. As shown in FIG. 6, the encryption/decryption device 6 includes a data acquisition module 61, a key acquisition module 62, and an encryption/decryption module 63. The data acquisition module 61 is used to obtain input data. The key acquisition module 62 is used to obtain the key and to perform key expansion to generate the round keys. The encryption/decryption module 63 is used to encrypt/decrypt the input data using the encryption/decryption method according to one embodiment of the present disclosure.

It should be understood that the system, apparatus, or method disclosed in the present disclosure may be implemented in alternative ways. For example, the apparatus embodiments described above are merely illustrative. For instance, the division of modules/units is just a logical functional division, and there may be other ways of division in actual implementation. For example, multiple modules or units may be combined or integrated into another system, or some features may be ignored or not executed. Furthermore, the coupling or direct coupling or communicative connection between two elements may be through some interfaces, and the indirect coupling or communicative connection between devices, modules, or units may be electrical, mechanical, or in other forms.

The modules/units described herein as separate components may be physically separate or not, and the components shown as modules/units may be physical modules or not, that is, they may be located in one place, or they may be distributed on multiple networked units. Some or all of the modules/units may be selected according to actual needs to achieve the purpose of the present disclosure. For instance, each functional module/unit of the present disclosure may be integrated into a processing module, or each module/unit may physically exist independently, or two or more modules/units may be integrated into one module/unit.

Those skilled in the art should further realize that the units and algorithm steps disclosed in the examples described in the present disclosure may be implemented with electronic hardware, computer software, or a combination of both. To clearly illustrate the interchangeability of hardware and software, the components and steps of each example have been generally described according to their functions in the above specification. Whether these functions are executed in hardware or software depends on the specific application and design constraints of the technical solution. Professionals can use different methods to implement the described functions for each specific application, and such implementations should not be considered beyond the scope of the present disclosure.

In summary, the present disclosure provides an encryption/decryption method and an encryption/decryption device. In the encryption/decryption method, intermediate data in the encryption/decryption engine are masked, and attackers cannot infer the internal operation process and related data of the engine by means of power consumption analysis or the like, which greatly improves the ability of the device to respond to DPA attacks. In addition, the masks used in the encryption/decryption method are all random numbers, which is conducive to further enhancing security. Further, instead of performing S-box transformations in a look-up table manner, the present disclosure is able to use an arithmetic manner to realize S-box transformations. The present disclosure introduces masks, making the DPA attack targets, such as power consumption, more random, further enhancing the ability to resist DPA attacks. Therefore, the present disclosure effectively overcomes the defects in the present disclosure and have high industrial value and wide application prospects.

The descriptions of the processes or structures corresponding to the various figures may emphasize different aspects. Parts not detailed in a particular process or structure may be referenced in the descriptions of other relevant processes or structures.

The above-mentioned embodiments are merely illustrative of the principle and effects of the present disclosure instead of restricting the scope of the present disclosure. Any person skilled in the art may modify or change the above embodiments without violating the principle of the present disclosure. Therefore, all equivalent modifications or changes made by those who have common knowledge in the art without departing from the spirit and technical concept disclosed by the present disclosure shall be still covered by the claims of the present disclosure.

What is claimed is:

1. An encryption/decryption method, comprising: performing a plurality of rounds of operations based on input data and a key to generate output data, wherein each round of operations processes N blocks of data to generate respective round output data, wherein the N blocks of data in a first round of operations are obtained by random masking the input data, and the N blocks of data in each of remaining rounds of operations are obtained based on N−1 blocks of data and the round output data from a previous round, and wherein N is a positive integer greater than 1;
wherein in each round of operations, the method further comprises:
performing random masking based on the N−1 blocks of data and a round key rkᵢ of the i-th round to generate first data, wherein the round keys are generated by a key generator;
performing nonlinear transformation on the first data using at least one masked S-box by a nonlinear processor to generate second data;
performing linear transformation on the second data by a linear processor to generate third data;
performing a first XOR operation on a remaining one block of data of the current round and the third data by a first XOR operation unit to generate fourth data; and
performing masking on the fourth data by a masking processor to generate the round output data of the current round.

2. The method according to claim 1, further comprising: performing a second XOR operation on N first random numbers and the input data by a second XOR operation unit to generate the N blocks of data for the first round of operations, wherein the first random numbers are generated by a random number generator.

3. The method according to claim 1, further comprising: performing, by the key generator, a third XOR operation on N second random numbers and the key and performing key expansion based on a result of the third XOR operation to generate the round keys, wherein the second random numbers are generated by the random number generator.

4. The encryption/decryption method according to claim 1, wherein performing random masking based on the N−1 blocks of data and a round key rkᵢ of the i-th round to generate first data comprises:
performing a fourth XOR operation on a round random number, said round key, and the N−1 blocks of data of the current round by a fourth XOR operation unit to generate the first data.

5. The encryption/decryption method according to claim 4, further comprising:
generating the round random number using a third random number, wherein the round random number varies across different rounds, and the third random number is generated by the random number generator.

6. The encryption/decryption method according to claim 1, wherein performing nonlinear transformation on the first data by the nonlinear processor using the masked S-box to generate the second data comprises:
performing affine transformation on the first data to generate fifth data;
performing mask inversion on the fifth data in Galois field to generate sixth data; and
performing affine transformation on the sixth data to generate the second data.

7. The encryption/decryption method according to claim 1, further comprising: adding the round output data from the previous round to the N−1 blocks of data from the previous round to form the N blocks of data of the current round of operations.

8. The encryption/decryption method according to claim 1, further comprising:
adding the round output data from a final round after the N−1 blocks of data from the final round to form seventh data;
performing a reverse-order processing on the seventh data to generate eighth data; and
performing unmasking on the eighth data to generate the output data.

9. The method according to claim 1,
wherein the input data are plaintext data and the output data are ciphertext data; or
wherein the input data are ciphertext data and the output data are plaintext data.

10. The encryption/decryption method according to claim 1, wherein N=4, and the plurality of rounds of operations consists of 32 rounds of operations.

11. An encryption/decryption device, comprising:
a data acquisition module, configured to acquire input data;
a key acquisition module, configured to acquire a key and generate a plurality of round keys by a key generator; and
an encryption/decryption module, configured to perform a plurality rounds of operations based on the input data and the key to generate output data, wherein each round of operations processes N blocks of data to generate round output data, wherein the N blocks of data in a first round of operations are obtained by random masking the input data, and the N blocks of data in each of remaining rounds of operations are obtained based on N−1 blocks of data and the round output data from a previous round, wherein N is a positive integer greater than 1;
wherein in each round of operations, the encryption/decryption module is configured to:
perform random masking based on the N−1 blocks of data and a round key rkᵢ of the i-th round to generate first data, wherein the round keys are generated by a key generator;
perform nonlinear transformation on the first data using at least one masked S-box by a nonlinear processor to generate second data;
perform linear transformation on the second data by a linear processor to generate third data;
perform a first XOR operation on a remaining one block of data of the current round and the third data by a first XOR operation unit to generate fourth data; and
perform masking on the fourth data by a masking processor to generate the round output data of the current round.
